(19) United States
(12) Patent Application Publication
(10) Pub. No.: US 2021/0185954 A1
(43) Pub. Date: Jun. 24, 2021

(54) MULTIPURPOSE PLANT GROWING APPARATUS

(71) Applicant: 4D BIOS Co., Ltd., Hangzhou, Zhejiang (CN)

(72) Inventors: Minhong Xie, Hangzhou, Zhejiang (CN); Wei Liu, Hangzhou, Zhejiang (CN)

(21) Appl. No.: 16/764,400

(22) PCT Filed: May 14, 2019
(86) PCT No.: PCT/CN2019/086752

§ 371 Date: May 15, 2020

(30) Foreign Application Priority Data
Mar. 14, 2019 (CN) 201910193806.X
Mar. 14, 2019 (CN) 201920326288.X

(51) Int. Cl. A01G 31/06; A01G 7/04

(52) U.S. Cl. CPC A01G 31/06; A01G 7/045

(57) ABSTRACT

The present invention provides a multipurpose plant growing apparatus, comprising a base having a nutrient solution cavity at its bottom and an LED illuminating device arranged above the base, wherein the base comprises a planting plate capping on the top of the nutrient solution cavity and providing with planting holes, a cup lid capable of abutting on the surface of the plate around the planting hole, and a culturing cup and a planting basket capable of being mounted on the cup lid and extending into the nutrient solution cavity. During using, the culturing cup (14) or the planting basket (13) can be connected to the cup lid (12). The multipurpose plant growing apparatus effectively solves the problem that existing growing apparatus are merely applicable to one single type of plants relative to various types of plants and makes it possible to grow different types of plants by the growing apparatus.

### FIELD OF THE INVENTION

The present invention relates to the field of plant growing technology, more particularly to a multipurpose plant growing apparatus.

### BACKGROUND OF THE INVENTION

In modern agriculture, conventional planting technology in which plants grow with sunlight is out of use, and the LED light is used to replace sunlight. Plants illuminated by the LED light can carry out photosynthesis. Hence, it is possible to grow plants indoors.

Indoor apparatus for growing vegetables, fruits and flowers are known. Such apparatus, such as planting containers for hydroponic plants, usually grow the plants by hydroponics. Such planting containers grow the plants in such a manner that the plants immerse in nutrient solution to absorb nutrients, photosynthesize and grow up.

In addition, less commonly, growth substance such as soil or some medium taking the place of soil may be disposed in a growing barrel for plants. Plant seeds, mycelia or strains may be planted. In the media growing method, some medium for plants growing may be disposed in a growing container, and the plant roots are fixed in the medium and absorb nutrients to grow up.

However, existing plant growing apparatus are only applicable for one single growing method, and thus selections of the plants are very limited. Furthermore, since some plants can grow fast by hydroponics while some plants may not be suitable for hydroponic culture, problems may occur in the case that different plants are planted in same plant growing apparatus. Moreover, due to different nutrient requirements and different growth periods, it is necessary to grow plants independently from each other.

In conclusion, how to effectively solve the problem that existing plant growing apparatus are merely applicable to one single type of plants relative to various types of plants has become an urgent problem to be solved in the art.

### SUMMARY OF THE INVENTION

The present invention aims to provide a multipurpose plant growing apparatus which effectively solves the problem that existing plant growing apparatus are merely applicable to one single type of plants relative to various types of plants and makes it possible to grow different types of plants by the plant growing apparatus.

In order to solve the above technical problem, the present invention provides a technical solution as follows.

A multipurpose plant growing apparatus comprises a base having a nutrient solution cavity at its bottom and an LED illuminating device arranged above the base, wherein the base comprises a planting plate capping on the top of the nutrient solution cavity and providing with planting holes, a cup lid capable of abutting on the surface of the plate around a planting hole, and a culturing cup and a planting basket which are capable of being mounted on the cup lid and extending into the nutrient solution cavity. When growing plants, the culturing cup or the planting basket is connected to the cup lid.

Preferably, the cross section of the inner circumference of the culturing cup has a greater size than the cross section of the outer circumference of the planting basket.

Preferably, a depression is formed in the central portion of the cup lid and is provided with a through-hole having an area smaller than the area of the depression, the top surface of the planting basket can be held over the through-hole, and the portion of the planting basket lower than the top surface can pass through the through-hole.

Preferably, a plurality of stop grooves are provided on the outer periphery of the upper end surface of the culturing cup, and the cup lid is provided with stop blocks matching with the stop grooves.

Preferably, the planting holes of the planting plate are circular holes, and a recess portion is formed at the edge of each circular hole and forms an annulus concentric with respective circular hole, the cup lid is circular shaped, an annular protrusion is formed at the lower side surface of the cup lid, the annular protrusion can enter into the circular hole, and the portion of the cup lid outward than the annular protrusion abuts on the recess portion.

Preferably, the upper side surface of the cup lid is flush with the planting plate in the case that the cup lid is disposed at the circular hole.

Preferably, a retaining notch is formed on the side wall of the circular hole, and a retaining protrusion matching with the retaining notch is formed on the outer wall of the annular protrusion.

Preferably, the stop groove is provided on the inner surface of the annular protrusion.

Preferably, the depression of the cup lid forms a concentric circular depression having a smaller radius than the outer diameter of the cup lid, and the through-hole of the depression is a square shaped hole which has a same center point as that of the concentric circular depression.

Preferably, the square shaped hole has a diagonal line with a length similar to the diameter of the concentric circular depression.

Preferably, the top surface of the planting basket is a circular surface which has a diameter which equals to the diameter of the concentric circular depression.

Preferably, the top surface of the planting basket is flush with the upper side surface of the cup lid in the case that the planting basket is fitted in the cup lid.

Preferably, the lower half portion that is connected with the circular surface of the planting basket is a hollowed-out support frame.

Preferably, the hollowed-out support frame is disposed with a sponge or silica gel for positioning the plants.

Preferably, the side frames of the hollowed-out support frame are regular rectangular truncated pyramid shaped and have a cross section which decreases in a direction towards the bottom, and the hollowed-out support frame is provided at its bottom surface with an annular frame line.

Preferably, the whole culturing cup has a circular truncated cone shaped cup body, the growing media can be disposed in the culturing cup, the center of the cup bottom of the culturing cup is provided with an opening, a thin tube is connected to the opening, the opening extends through the cup bottom and the thin tube, and the thin tube is provided at its bottom with an absorbing notch.

Preferably, the LED illuminating device is a light cover which is connected with the base by a supporting connection rod, a lamp panel arranged with a plurality of LED lamp beads is mounted on the lower surface of the light cover.

Preferably, the multipurpose plant growing apparatus is hollowed-out at four sides, and the multipurpose plant growing apparatus is made of plastics.

Preferably, the upper portion of the cup lid is arranged with a handle to facilitate moving.

The multipurpose plant growing apparatus of the present invention comprises a base having a nutrient solution cavity at its bottom and an LED illuminating device arranged above the base, wherein the base comprises a planting plate capping on the top of the nutrient solution cavity and providing with planting holes, a cup lid capable of abutting on the surface of the plate around a planting hole, and a culturing cup and a planting basket which are capable of being mounted on the cup lid and extending into the nutrient solution cavity. During using, the culturing cup or the planting basket can be connected to the cup lid.

The multipurpose plant growing apparatus of the present invention solves the problem that existing plant growing apparatus are merely applicable to one single type of plants relative to various types of plants. It is capable of planting plants by two methods. In the condition that some plants can grow fast by hydroponics while some plants may not be suitable for hydroponic culture, it has very good adaptability for the selections of the plants. Furthermore, different plants can be planted in same plant growing apparatus, and the problem that the plant growing apparatus has very high plant growing portion having high weight and volume ratios due to the hydroponics nutrient solution is solved.

### BRIEF DESCRIPTION OF THE DRAWINGS

To facilitate the detailed description of embodiments according to the present invention or prior art, drawings illustrating the embodiments or prior art will be briefly described below. It is apparent that the drawings described below merely illustrate some embodiments of the present invention. Based on these drawings, those skilled in the art may obtain some other drawings without any creative work.

FIG. 1 is a schematic drawing of a multipurpose plant growing apparatus according to a particular embodiment of the present invention;

FIG. 2 is a schematic drawing of a planting plate;

FIG. 3 is a schematic drawing of a cup lid;

FIG. 4 is a bottom view of a cup lid;

FIG. 5 is a schematic drawing of a planting basket;

FIG. 6 is a schematic drawing of a culturing cup.

Reference numerals used in the drawings are as follows: 1. base; 2. supporting connection rod; 3. light cover; 11. planting plate; 111. planting holes; 112. retaining notch; 12. cup lid; 121. through-hole; 122. handle; 123. annular protrusion; 124. retaining protrusion; 125. stop blocks; 13. planting basket; 131. hollowed-out support frame; 14. culturing cup; 141. stop grooves; 142. thin tube; 143. absorbing notch.

### DETAILED DESCRIPTION OF ILLUSTRATED EMBODIMENTS

A core of the present invention is to provide a multipurpose plant growing apparatus which effectively solves the problem that existing plant growing apparatus are merely applicable to one single type of plants relative to various types of plants and makes it possible to grow different types of plants by the plant growing apparatus.

Embodiments of the present invention will be clearly and completely described in conjunction with the attached drawings. It is apparent that the embodiments described below are merely some, but not all, embodiments of the present invention. Based on the embodiments of the present invention, those skilled in the art may obtain other embodiments included within the scope of the present invention without any creative work.

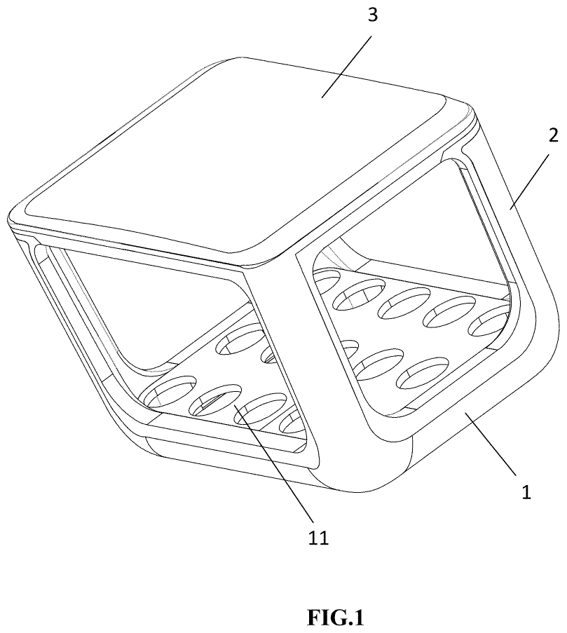

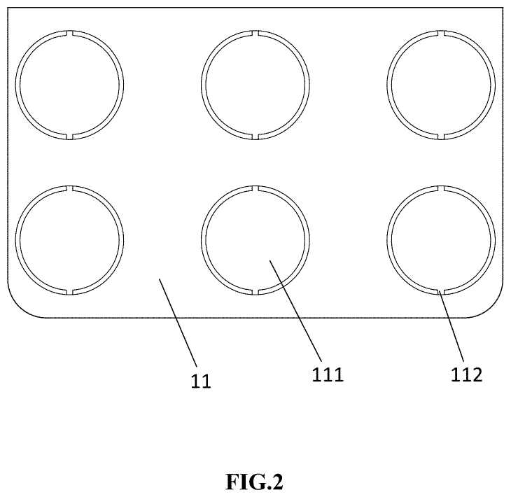

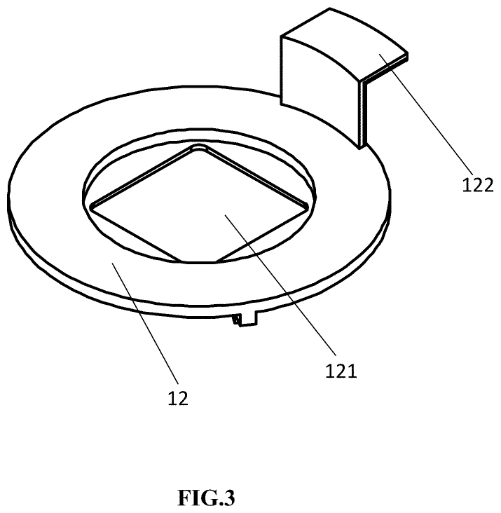

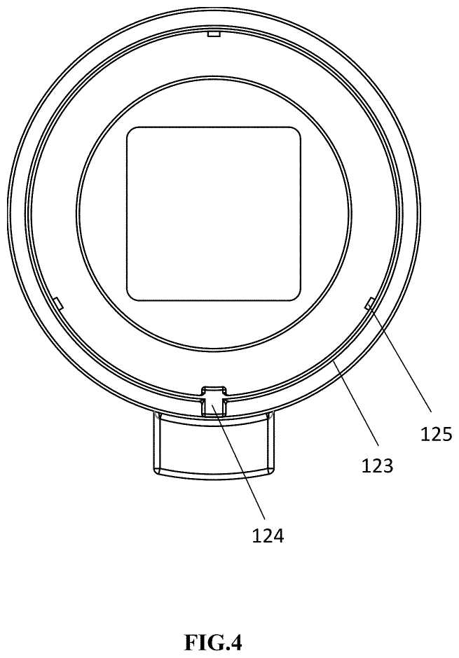

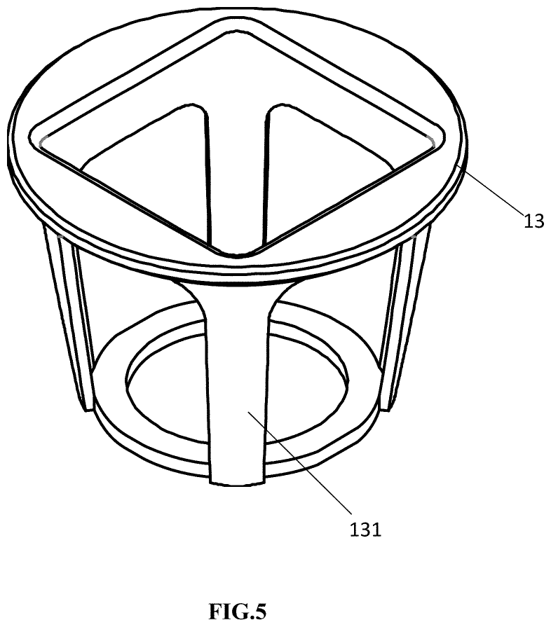

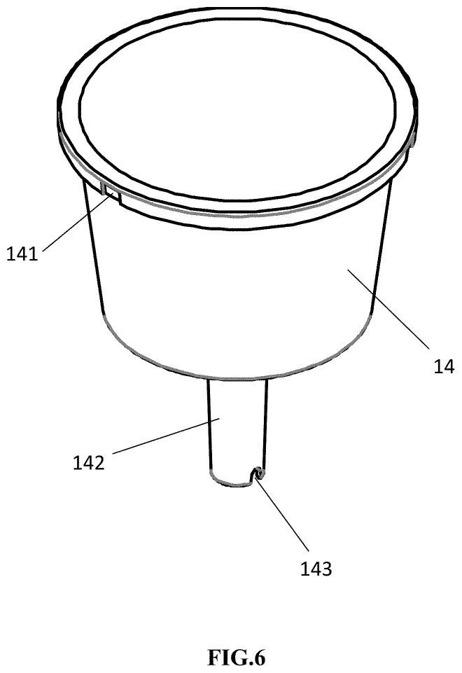

Referring to FIGS. 1-6, FIG. 1 is a schematic drawing of a multipurpose plant growing apparatus according to a particular embodiment of the present invention; FIG. 2 is a schematic drawing of a planting plate; FIG. 3 is a schematic drawing of a cup lid; FIG. 4 is a bottom view of a cup lid; FIG. 5 is a schematic drawing of a planting basket; FIG. 6 is a schematic drawing of a culturing cup.

In a particular embodiment, a multipurpose plant growing apparatus of the present invention comprises a base 1 having a nutrient solution cavity at its bottom and an LED illuminating device arranged above the base 1, wherein the base 1 comprises a planting plate 11 capping on the top of the nutrient solution cavity and providing with planting holes 111, a cup lid 12 capable of abutting on the surface of the plate around a planting hole 111, and a culturing cup 14 and a planting basket 13 which are capable of being mounted on the cup lid 12 and extending into the nutrient solution cavity. To plant plants, the culturing cup 14 or the planting basket 13 can be connected to the cup lid 12.

It should be noted that, the nutrient solution cavity which serves to provide nutrients for the plants is arranged at the bottom of the base 1. The LED illuminating device arranged above the base 1 takes the place of sunlight such that the plants illuminated by the LED light can carry out photosynthesis.

In the above configuration, the base 1 comprises a planting plate 11, a cup lid 12, a culturing cup 14 and a planting basket 13, wherein the planting plate 11 caps on the top of the nutrient solution cavity, that is, the upper surface of the base 1 is defined by the one planting plate 11. The planting plate 11 is provided with planting holes 111, through which the plant roots can extend into the nutrient solution cavity.

It should be noted that, the cup lid 12 may abut on the surface of the plate around a planting hole 111 means, the cup lid 12 may be disposed at a planting hole 111, and the cup lid 12 is removably connected with the planting plate 11. To plant plants, the cup lid 12 can be removed from the planting plate 11 so as to connect various planting containers such as the culturing cup 14 and the planting basket 13.

In the above configuration, the culturing cup 14 and the planting basket 13 can be mounted on the cup lid 12 and extend into the nutrient solution cavity. To plant plants, the culturing cup 14 or the planting basket 13 can be connected to the cup lid 12. In other words, both the culturing cup 14 and the planting basket 13 can be removably connected with the cup lid. Specifically, if the culturing cup 14 is needed, the cup lid 12 can be connected with the culturing cup 14, and the planting basket 13 can be removed from the cup lid 12; if the planting basket 13 is needed, the cup lid 12 can be connected with the planting basket 13, and the culturing cup 14 can be removed from the cup lid 12. The planting basket 13 and the culturing cup 14 which can be alternatively connected with the cup lid 12 are easy and convenient to use and do not interfere with each other.

The multipurpose plant growing apparatus of the present invention solves the problem that existing plant growing apparatus are merely applicable to one single type of plants relative to various types of plants. It is capable of planting plants by two methods. In the condition that some plants can grow fast by hydroponics while some plants may not be suitable for hydroponic culture, it has very good adaptability for the selections of the plants. Furthermore, different plants can be planted in same plant growing apparatus, and the problem that the plant growing apparatus has very high plant growing portion having high weight and volume ratios due to the hydroponics nutrient solution is solved.

If neither the culturing cup 14 nor the planting basket 13 is needed, the cup lid 12 can be connected with both the culturing cup 14 and the planting basket 13, or none of the culturing cup 14 and the planting basket 13, or anyone of the culturing cup 14 and the planting basket 13. In order to save space, the cup lid 12 may be preferably connected with both the culturing cup 14 and the planting basket 13. In the case that both the culturing cup 14 and the planting basket 13 are connected to the cup lid 12, the cross section of the inner circumference of the culturing cup 14 has a greater size than the cross section of the outer circumference of the planting basket 13, such that the planting basket 13 can be accommodated in the culturing cup 14, thereby saving space, reducing required area, and allowing easier placement. Furthermore, since the culturing cup 14, the planting basket 13 and the cup lid 12 can be nested one by one, they can be put together and stocked as a set when not in use, thereby facilitating taking-out if desired and avoid loss.

Based on the above particular embodiment, a depression is formed in the central portion of the cup lid 12, and the depression is provided with a through-hole 121 having an area smaller than the area of the depression, such that the plant is capable of extending into the nutrient solution cavity through the through-hole 121. The planting basket 13 can be supported by the portion of the depression around the through-hole 121 and prevented from falling off. The planting basket 13 can be connected with the cup lid 12 in such a manner that the top surface of the planting basket 13 is held over the through-hole 121, and the portion of the planting basket 13 lower than the top surface can pass through the through-hole 121 such that the bottom of the planting basket 13 extends into the nutrient solution cavity. The combination of the planting basket 13 and the cup lid 12 is applicable for the hydroponic culture of the plant culture. The assembly can be disposed on the culturing plate. A cuboid sponge in which a general plant seedling or a seed is fixedly positioned can be disposed in the planting basket 13, whereby the plant disposed in the planting basket 13 can be fixed there. In such case, the whole plant roots not only can be fixed, but also can pass through the planting basket 13 to absorb nutrients from the nutrient solution.

Based on the above particular embodiment, a plurality of stop grooves 141 are provided on the outer periphery of the upper end surface of the culturing cup 14, and the cup lid 12 is provided with stop blocks 125 matching with the stop grooves 141. In the case that the culturing cup 14 is connected with the cup lid 12, the stop grooves 141 of the culturing cup 14 and the stop blocks 125 of the cup lid 12 can be engaged with each other. The combination of the culturing cup 14 and the cup lid 12 is applicable for the growing media culture. The assembly can be disposed on the culturing plate. When planting, a growing medium in which a plant seed or seedling is disposed can be disposed in the culturing cup 14. In the case that the assembly of the cup lid 12 and the culturing cup 14 is disposed in the base 1, due to the increased water pressure and the siphonic effect, the nutrient solution can be absorbed by the growing medium in the cup body from the bottom of the culturing cup 14 and supplied for the plant roots.

Based on the above particular embodiment, the planting holes 111 of the planting plate 11 are circular holes, and a recess portion is formed at the edge of each circular hole and forms an annulus concentric with respective circular hole. The cup lid 12 may be circular shaped, and an annular protrusion 123 may be formed at the lower side surface of the cup lid 12. The annular protrusion 123 can enter into the circular hole. A bottom surface of the portion of the cup lid outward than the annular protrusion 123 may abut on the recess portion, such that in the case that the cup lid 12 is disposed at the circular hole, the upper side surface of the cup lid 12 is flush with the planting plate 11.

In the above configuration, the shape of the planting hole 111 is not limited, and circular holes, square holes, and irregular shaped hole are all conceivable. Preferably, the planting hole 111 may be circular shaped and do not have any corner, such that the plant roots which usually are circular shaped will not get stuck, thereby facilitating growing and pruning of the plants and improving the aesthetic appearance.

It should be noted that, the recess portion formed at the edge of each circular hole may be square shaped or circular shaped, depending on particular practical application, which is not limited in the present invention. Preferably, the recess portion forms an annulus concentric with respective circular hole. In such case, the cup lid 12 may be circular shaped, which facilitates the connection with the planting plate 11 and prevents the users from being injured.

Preferably, in the case that the annular protrusion 123 is formed at the lower side surface of the cup lid 12, it should be noted that the outer diameter of the annular protrusion 123 is smaller than or equals to the inner diameter of the circular hole, such that the annular protrusion 123 can enter into the circular hole. In the case that the planting plate 11 is connected with the cup lid 12, the annular protrusion 123 enters into the circular hole, the bottom surface of the portion of the cup lid outward than the annular protrusion 123 abuts on the recess portion. In such case, the cup lid 12 is disposed at the circular hole in a manner that the upper side surface of the cup lid 12 is flush with the planting plate 11, whereby the planting plate 11 maintains a flat surface and has a neater and aesthetic appearance.

In a further preferred technical solution, a retaining notch 112 serving as position restraining points for the cup lid 12 may be formed on the side wall of the circular hole. One retaining notch 112 may be provided, to facilitate simple structure and easy processing. Two retaining notches 112 may be provided, at opposite positions spaced apart at 180 degrees. Alternatively, a plurality of retaining notches 112 may be provided, preferably evenly spaced apart. A retaining protrusion 124 matching with the retaining notch 112 may be formed on the outer wall of the annular protrusion 123, such that the cup lid 12 and the planting plate 11 can be fitted with each other and fixed relative to each other, whereby the cup lid 12 can be fixed at the planting plate 11 and prevented from swinging and rotating. The shape and the size of the retaining notch 112 is not limited in the present invention, well-known details are not described herein.

In a further preferred technical solution, a stop groove 141 may be provided on the inner surface of the annular protrusion 123. The inner surface of the annular protrusion 123 is a surface which may be in contact with the culturing cup 14. The cup lid 12 and the culturing cup 14 may have resilience, and the inner diameter of the annular protrusion 123 may be equal to the outer diameter of the culturing cup 14, such that they can tightly fit with each other and the culturing cup 14 can be fixed due to the annular protrusion 123 of the cup lid 12. Due to the stop grooves 141 and the stop blocks 125, the culturing cup 14 can be further fixed. Since the stop grooves 141 and the stop blocks 125 are engaged with each other, a contact area is increased and the chucking force is increased, whereby the culturing cup 14 can be prevented from being released from the cup lid 12. It should be noted that at least three stop grooves 141 may be provided, preferably evenly spaced apart. In such case, the culturing cup 14 is subjected to more even force and can be better fixed. Alternatively, the stop grooves 141 and the stop blocks 125 may have any suitable shapes such as triangle and rectangle, which is not limited in the present invention.

Based on the above particular embodiment, the depression of the cup lid 12 forms a concentric circular depression having a smaller radius than the outer diameter of the cup lid 12. The through-hole 121 of the depression may be a square shaped hole which has a same center point as that of the concentric circular depression and a diagonal line with a length similar to the diameter of the concentric circular depression. In such case, the portion of the concentric circular depression greater than the square shaped hole has a regular shape and is neat, and the planting basket 13 has a regular shape and is not intended to be displaced.

In a further preferred technical solution, the top surface of the planting basket 13 is a circular surface which has a diameter which equals to the diameter of the concentric circular depression. In such case, the planting basket 13 can be disposed just in the cup lid 12, such that they are in close contact with each other and tightly fit with each other to avoid swinging. In the case that the planting basket 13 is fitted in the cup lid 12, the upper side surface of the cup lid 12 is flush with the top surface of the planting basket 13, such that the cup lid 12 maintains a flat surface without any protrusion and avoids the risk of injuring the users.

Based on the above particular embodiment, the lower half portion that is connected with the circular surface of the planting basket 13 is a hollowed-out support frame 131. The hollowed-out support frame 131 may be disposed with a sponge or silica gel for positioning the plants. A cuboid sponge in which a general plant seedling or a seed is fixedly positioned can be disposed in the hollowed-out structure, whereby the plant disposed in the hollowed-out support frame 131 can be fixed there. In such case, the whole plant roots not only can be fixed, but also can pass through the hollowed-out structure to absorb nutrients from the nutrient solution.

In a further preferred technical solution, the side frames of the hollowed-out support frame 131 are regular rectangular truncated pyramid shaped and have a cross section which decreases in a direction towards the bottom. The hollowed-out support frame 131 is provided at its bottom with an annular frame line, which serves to support the sponge when the sponge is disposed over there and to a certain extent provides an out-expanding space for the sponge when the sponge is compressed, thereby preventing the sponge from pressing inwards and damaging the plant roots.

Based on the above particular embodiment, the whole culturing cup 14 has a circular truncated cone shaped cup body. The growing media can be disposed in the culturing cup 14. The center of the cup bottom of the culturing cup 14 is provided with an opening, and the opening may be a circular opening. A thin tube 142 may be connected to the opening. The opening can be easily connected with the thin tube 142. The opening extends through the cup bottom and the thin tube 142. As long as the thin tube 142 and the opening are clear, the plants can smoothly absorb the nutrient solution. Preferably, the thin tube 142 is provided at its bottom with an absorbing notch 143. In the case that the thin tube 142 is in contact with the bottom of the base 1 of the plant growing apparatus, the nutrient solution can flow through the absorbing notch 143. Furthermore, the impact to the plants in the cup body resulted from the flowing of the liquid during refilling of the nutrient solution can be reduced. The thin tube 142 and the culturing cup 14 may be formed integrally, or connected by means of a connecting sleeve. The thickness of the thin tube 142 may be selected depending on particular practical application, which is not limited in the present invention.

Based on the above particular embodiment, the LED illuminating device may be a light cover 3, which is connected with the base 1 by a supporting connection rod 2. Preferably, the multipurpose plant growing apparatus may be hollowed-out at four sides, to facilitate moving of the growing unit and harvesting plants. It has low cost and increased growing space for the plants.

Meanwhile, a lamp panel arranged with a plurality of LED lamp beads may be mounted on the lower surface of the light cover 3. The connection between the LED lamp beads and the lamp panel known in the art is not described herein. The numbers and the position arrangements of the LED lamp beads may be determined individually depending on various particular practical applications, which is not limited in the present invention.

In a further preferred technical solution, the multipurpose plant growing apparatus is made of plastics such as PS, PP, PC, PET, which has light weight, and is stable and easy to move, and is not easy to rust. The upper portion of the cup lid 12 may be arranged with a handle 122 to facilitate moving of the cup lid 12.

The embodiments of the present invention are described in a progressive manner. Each embodiment is described with an emphasis on a difference from the other embodiments, and same and similar arrangements are not repeated.

The multipurpose plant growing apparatus of the present invention has been described as above. The principles and embodiments of the present invention are illustratively described with reference to particular embodiments disclosed above. The description with reference to the embodiments is merely illustrative of the principle and concept of the present invention. It should be noted that the present invention is intended to cover all changes and various modifications those skilled in the art may obtain within the principle of the present invention. Thus, the present invention will not be limited to the embodiment disclosed above, but shall accord with the widest scope consistent with the principles and now characteristics disclosed herein.

1. A multipurpose plant growing apparatus, wherein the apparatus comprises a base (1) having a nutrient solution cavity at a bottom of the base and an LED illuminating device arranged above the base (1), wherein the base (1) comprises a planting plate (11) capping on a top of the nutrient solution cavity and providing with a planting hole (111), a cup lid (12) capable of abutting on a surface of the plate around the planting hole (111), and a culturing cup (14) and a planting basket (13) which are capable of being mounted on the cup lid (12) and extending into the nutrient solution cavity, and the culturing cup (14) or the planting basket (13) can be connected to the cup lid (12) during planting.

2. The multipurpose plant growing apparatus according to claim 1, wherein a cross section of an inner circumference of the culturing cup (14) has a greater size than a cross section of an outer circumference of the planting basket (13).

3. The multipurpose plant growing apparatus according to claim 1, wherein a depression is formed in a central portion of the cup lid (12) and is provided with a through-hole (121) having an area smaller than an area of the depression, a top surface of the planting basket (13) can be held over the through-hole (121), and a portion of the planting basket lower than the top surface can pass through the through-hole (121).

4. The multipurpose plant growing apparatus according to claim 1, wherein a plurality of stop grooves (141) are provided on an outer periphery of an upper end surface of the culturing cup (14), and the cup lid (12) is provided with stop blocks (125) matching with the stop grooves (141).

5. The multipurpose plant growing apparatus according to claim 4, wherein the planting hole (111) of the planting plate (11) is a circular hole, and a recess portion is formed at an edge of the circular hole and forms an annulus concentric with the circular hole, the cup lid (12) is circular shaped, an annular protrusion (123) is formed at a lower side surface of the cup lid, the annular protrusion (123) can enter into the circular hole, and a portion of the cup lid outward than the annular protrusion (123) can abut on the recess portion.

6. The multipurpose plant growing apparatus according to claim 5, wherein an upper side surface of the cup lid (12) is flush with the planting plate (11) in the case that the cup lid (12) is disposed at the circular hole.

7. The multipurpose plant growing apparatus according to claim 5, wherein a retaining notch (112) is formed on a side wall of the circular hole, and a retaining protrusion (124) matching with the retaining notch (112) is formed on an outer wall of the annular protrusion (123).

8. The multipurpose plant growing apparatus according to claim 5, wherein the stop grooves (141) are provided on an inner surface of the annular protrusion (123).

9. The multipurpose plant growing apparatus according to claim 1, wherein the depression of the cup lid (12) forms a concentric circular depression having a smaller radius than an outer diameter of the cup lid (12), and the through-hole (121) of the depression is a square shaped hole which has a same center point as that of the concentric circular depression.

10. The multipurpose plant growing apparatus according to claim 9, wherein the square shaped hole has a diagonal line with a length similar to a diameter of the concentric circular depression.

11. The multipurpose plant growing apparatus according to claim 9, wherein a top surface of the planting basket (13) is a circular surface which has a diameter which equals to a diameter of the concentric circular depression.

12. The multipurpose plant growing apparatus according to claim 11, wherein the top surface of the planting basket (13) is flush with an upper side surface of the cup lid (12) in the case that the planting basket (13) is fitted with the cup lid (12).

13. The multipurpose plant growing apparatus according to claim 1, wherein a lower half portion connected with a circular surface of the planting basket (13) is a hollowed-out support frame (131).

14. The multipurpose plant growing apparatus according to claim 13, wherein the hollowed-out support frame (131) is disposed with a sponge or silica gel for positioning of a plant.

15. The multipurpose plant growing apparatus according to claim 13, wherein a side frame of the hollowed-out support frame (131) is regular rectangular truncated pyramid shaped and has a cross section which decreases in a direction towards a bottom of the side frame, and a bottom surface of the hollowed-out support frame (131) is provided with an annular frame line.

16. The multipurpose plant growing apparatus according to claim 1, wherein the whole culturing cup (14) has a circular truncated cone shaped cup body, a growing media can be disposed in the culturing cup (14), a center of a cup bottom of the culturing cup (14) is provided with an opening, to which a thin tube (142) is connected, the opening extends through the cup bottom and the thin tube (142), and a bottom of the thin tube (142) is provided with an absorbing notch (143).

17. The multipurpose plant growing apparatus according to claim 1, wherein the LED illuminating device is a light cover (3) which is connected with the base (1) by a supporting connection rod (2), and a lamp panel arranged with a plurality of LED lamp beads is mounted on a lower surface of the light cover (3).

18. The multipurpose plant growing apparatus according to claim 1, wherein the multipurpose plant growing apparatus is hollowed-out at four sides, and the multipurpose plant growing apparatus is made of plastics.

19. The multipurpose plant growing apparatus according to claim 1, wherein an upper portion of the cup lid (12) is arranged with a handle (122) to facilitate moving.

20. The multipurpose plant growing apparatus according to claim 2, wherein a plurality of stop grooves (141) are provided on an outer periphery of an upper end surface of the culturing cup (14), and the cup lid (12) is provided with stop blocks (125) matching with the stop grooves (141).
